(19) United States
(12) Patent Application Publication
(10) Pub. No.: US 2010/0057613 A1
(43) Pub. Date: Mar. 4, 2010

(54) APPARATUS AND METHODS FOR CHECK CARD FEE WAIVER

(75) Inventor: Jarett S. Isralow, Charlotte, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/199,873

(22) Filed: Aug. 28, 2008

(51) Int. Cl. G06Q 30/00; G06Q 40/00

(52) U.S. Cl. 705/41; 705/14.13

(57) ABSTRACT

Apparatus and methods for waiving at least a portion of a service fee. The apparatus and methods may involve providing a check card to a customer and determining whether the customer is using the check card sufficiently to warrant waiving the fee or a portion of the fee. In some embodiments, the apparatus and methods may involve enrolling the customer in a check card program. The customer may select alerts regarding check card usage. The check card issuing entity may monitor the usage to reduce the risk of unauthorized use.

### FIELD OF TECHNOLOGY

Aspects of the disclosure relate to providing check card banking service. In particular, the disclosure relates to providing check card banking service to businesses.

### BACKGROUND

A banking institution may issue a check card to a business. A representative of the business may present the check card to a merchant at a point of sale (“POS”) to provide payment for a purchase. The merchant initiates an electronic transaction based on the check card. The electronic transaction simulates a purchase made with a paper check. As such, an electronic transaction network may draw funds from a checking account that is linked to the card.

Purchasing goods and services with a check card may be easier for the business than purchasing the same goods and services with a paper check. For example, a representative of the business may use the check card without being a named signatory, as is required for the use of a paper check. Also, the check card may reduce the manual effort required to maintain a checking account, because the check card may not require that the representative record transaction information by hand in a ledger at the point of sale.

Nevertheless, businesses have been slow to adopt check cards as purchasing instruments.

It would be desirable, therefore, to provide apparatus and methods for promoting the adoption of check cards as purchasing instruments for businesses.

### SUMMARY OF THE INVENTION

It is an object of the invention to provide apparatus and methods for waiving at least a portion of a fee for a banking service. Apparatus and methods for waiving at least a portion of the fee are therefore provided. The apparatus and methods may involve providing a check card to a customer, evaluating check card usage based on transactions executed using the check card, comparing the usage to a preselected requirement determined by an entity that issued the check card and, if the usage is sufficient, waiving the fee or a portion of the fee.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of apparatus that may be used in connection with the principles of the invention;

FIG. 2 shows an illustrative process in accordance with the principles of the invention;

FIG. 3 shows another illustrative process in accordance with the principles of the invention; and

FIG. 4 shows yet another illustrative process in accordance with the principles of the invention.

### DETAILED DESCRIPTION OF THE INVENTION

Apparatus and methods for waiving a fee for a banking service are provided. The apparatus and methods may involve providing a check card to a customer, tallying a check card usage metric based on transactions executed using the check card, comparing the usage metric to a preselected requirement and, if the usage metric is sufficient, waiving the fee or a portion of the fee.

The banking service may be provided by an entity such as a bank. The service may be a check card service. The check card service may be provided to a customer. The customer may be a small business, a mid-sized business, a large business or any other type of organization or entity. In some embodiments, the fee waiver may be offered to the customer to encourage the customer to engage in purchase transactions using the check card.

The check card may be used to charge against funds from a customer account that is provided by the bank. The customer account may be a commercial account, a small business account, a personal or consumer demand deposit account used for business purposes or any other suitable type of account.

The bank may charge the customer a fee for providing checking account services to the customer. The fee may be a monthly fee, a usage-based fee, a balance-based fee or any other suitable fee. For example, when the fee is a flat monthly fee, the bank may set a monthly qualifier (e.g., 10 point-of-sale (“POS”) transactions) that the customer will have to achieve to avoid the fee. When the customer achieves the required number of posted check card transactions within a billing cycle, the fee may be waived. In some embodiments, the fee may be automatically waived. In some embodiments, the fee waiver may take effect in the month after the customer satisfies the qualifier. In some embodiments, the fee may be partially waived based on check card usage that partially satisfies bank requirements.

In some embodiments, the qualifier may be based on the number of dollars spent using the check card, the number of transactions executed using the check card or any other suitable metric involving check card usage.

A customer having an existing check card account may enroll in a fee waiver program using a manual opt-in feature. In some embodiments, a customer may enroll in a check card account that has a built-in fee waiver feature. A bank associate may assist a customer in the enrollment process via a module based on, or interfaced with, any suitable retail banking customer service tools. Enrollment may be made permanent or temporary. Temporary enrollment may be conditional upon customer usage, credit behavior and the like.

Customer service tools may be provided with web screens that are customized for different lines of business (“LOB”) within a bank. Bank associates in the different LOBs may use the web screens to enroll and unenroll customer(s) on a temporary or permanent basis.

In some embodiments, qualifiers for the fee waiver may apply only to “qualified” transactions. Qualified transactions may include transactions of a predetermined type or size.

In some embodiments, qualified transactions may include POS, PIN-less, and PIN-based transactions. In some embodiments, ATM, cash, or quasi-cash transactions may be unqualified. For example, a money order purchased using the check card may not be a qualified transaction.

The qualified transactions may be applied to the waiver based on posted date, authorized date or any other suitable date. The bank may monitor a 12-month rolling history of the check card account. The history may show the fees and the fee waivers. In some embodiments a minimum customer account balance may be a requirement for fee waiver.

The bank may use billing cycle statements to communicate with the customer about the status of fees and fee waivers. In some embodiments, the statement may include a “fee counter” field that shows the status of fees, fee waivers, and/or qualified transactions. Status messages may be provided on the statements. The status messages may include, for example, “Fee assessed,” “Fee waived due to usage,” and “fee waived” based on a suitable criterion.

When the customer is a business, the business may have employees that use one or more cards that are linked to the customer's bank account. In some embodiments, statements may identify the employee that made one or more of the transactions. The statements may be paper or electronic.

Some embodiments may include a “grace period” after enrollment in the check card program (or, for new accounts, after inception of the account). The fee will be waived for the grace period. The grace period may be any suitable period, such as any number of days, weeks, months or years.

The apparatus and methods may provide for check card account management. Customer activity may be monitored based on one or more of transaction numbers, transaction frequency, transaction amounts and any other suitable customer activity metrics. The customer activity metrics may be compared to predetermined target values corresponding to the metrics.

The apparatus and methods may provide the bank with check card usage reports showing one or more of the metrics. The metrics may help identify customer behavior that is associated with customer gaming. One example of gaming is executing several small transactions in lieu of one large transaction. For example, if a fee waiver is contingent on the execution of a fixed number of transactions, a customer could “game” the program by separately, but on the same day, for example, purchasing multiple items from the same vendor. For example, a contractor may require lumber, tools and hardware to complete a job. Instead of purchasing them all in one transaction, the contractor could game the program by purchasing them in three (or more) serial transactions. Such behavior would artificially expedite the contractor's completion of the required fixed number of transactions.

Customers that are identified as engaging in gaming behavior may be unenrolled. Numerous customers engaging in such behavior may be unenrolled en masse—e.g., in a computerized batch process. Individual customers engaging in such behavior may be manually unenrolled. Unenrollment may be temporary or permanent.

In some embodiments, the apparatus and methods may involve customer selection of alerts. The alerts may inform the customer about the status of the customer's activities that count toward fee waiver. The alerts may be communicated to the customer at the time of a transaction. In one example, an email with status information may be sent to the customer. In another example, a POS device may print the status information on a purchase receipt.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

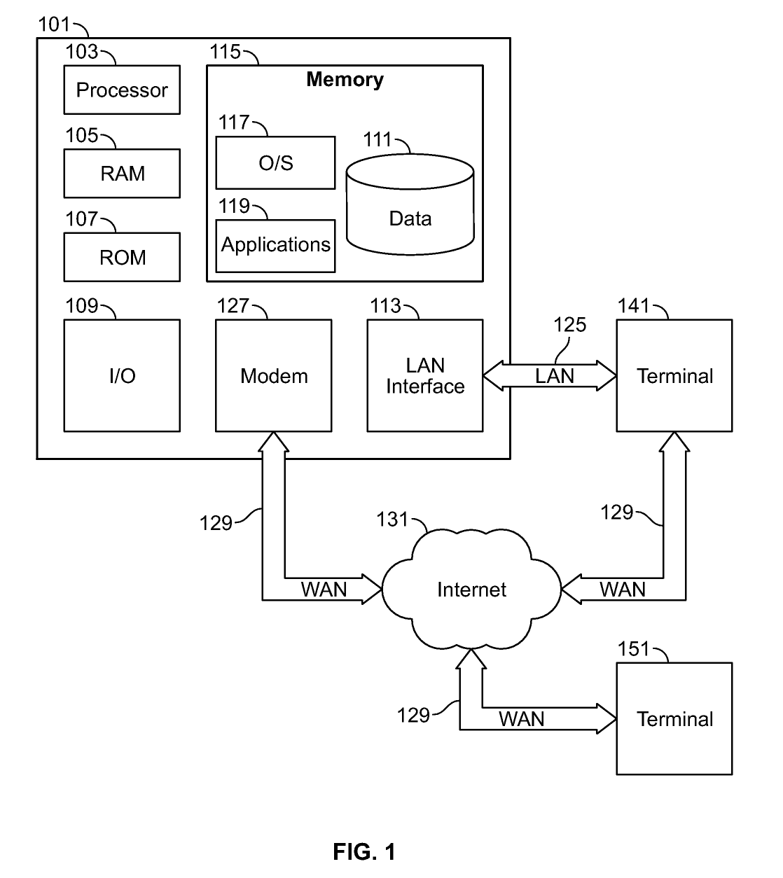

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 201 computer executable instructions may be embodied in hardware or firmware (not shown). As described in detail below, database 121 may provide storage for, customer transaction information, customer information and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Customer attribute information, including bank account information, may be stored in memory 125. The attribute information may be processed by an application such as one of applications 119.

One or more of applications 119 may include one or more algorithms that may be used to perform check card program enrollment, monitor check card usage, detect check card misuse and any other suitable tasks related to offering a check card program.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

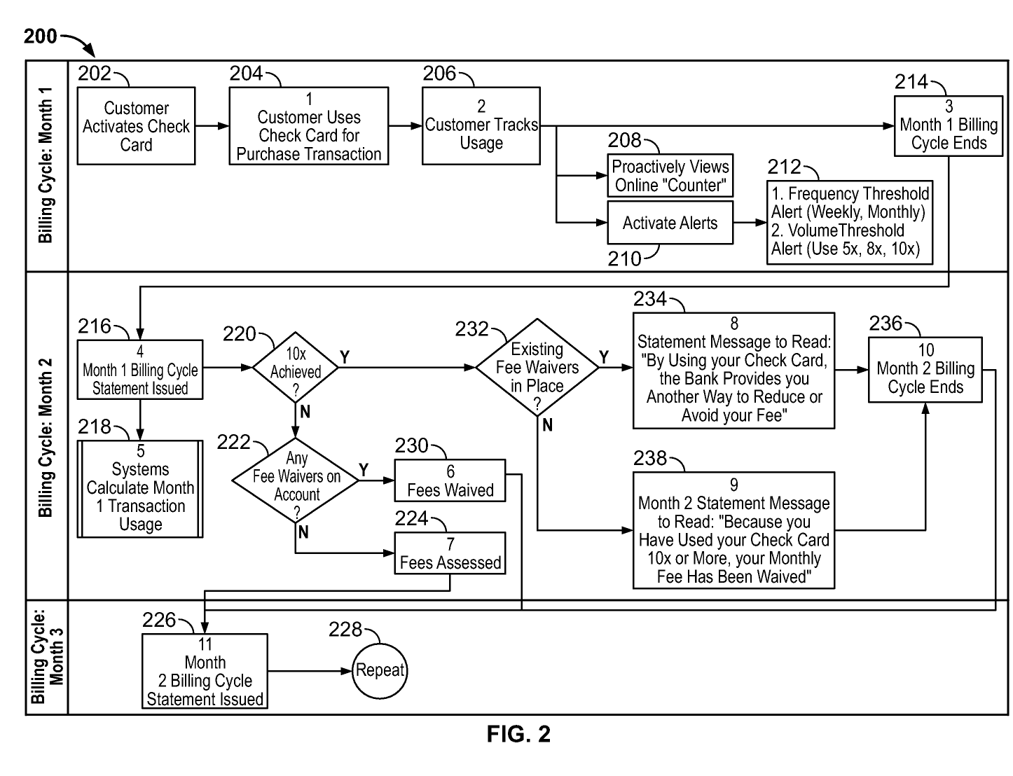

Processes in accordance with the principles of the invention may include one or more features of the processes illustrated in FIGS. 2-4. For the sake of illustration, the processes illustrated in FIGS. 2-4 will be described as being performed by a “system”. The “system” may involve one or more of the devices shown in FIG. 1, one or more of the devices, one or more individuals and/or any other suitable device or approach. The “system” may be provided by an entity. The entity may be an individual, an organization or any other suitable entity.

FIG. 2 shows illustrative process 200 for administering a check card program. Process 200 may be used when a customer enrolls in a check card program and begins using the check card. Process 200 may begin at step 202 in a first monthly billing cycle (“Billing Cycle: Month 1”) of an account linked to a check card in the program. At step 202, a bank customer activates the check card. At step 204, the customer uses the check card for a purchase transaction. At step 206, the customer may track the usage of the check card. At step 208, the customer may track the usage by viewing a web site showing a usage monitor. The usage monitor may be provided by the system. At step 210, the customer may activate one or more alerts. At step 212, the customer may select one or more predefined alerts.

The predefined alerts may include a frequency alert. The frequency alert may alert the customer when the customer's check card usage meets or exceeds a designated frequency threshold. For example, the designated frequency threshold may be a certain number of check card transactions per week, month or any other suitable time period.

The predefined alerts may include a threshold alert. The threshold alert may alert the customer when the customer's check card usage meets or exceeds a designated volume (or number) of transactions. For example, the designated volume threshold may be 5, 8, 10 or any other suitable number of transactions.

The predefined alert may include an “end-of-billing-cycle” alert that alerts the customer that the end of a billing cycle is approaching. Such an alert may prompt the customer to accelerate his check card activity to qualify for fee waiver before the billing cycle ends.

At step 214, Month 1 Billing Cycle ends.

Process 200 may continue during a second monthly billing cycle (“Billing Cycle: Month 2”) of the account. The first step of the second billing cycle may be step 216. At step 216, a Month 1 Billing Cycle Statement may be issued. At step 218, the system may calculate a Month 1 Transaction Usage. The Month 1 Transaction usage may be based on the Month 1 Billing Cycle Statement.

At step 220, the system may determine whether a threshold has been met. For example, the system may determine whether the check card has been used 10 times (“10× Achieved”). If 10× has not been achieved, process 200 may continue at step 222. At step 222, the system may determine whether any fee waivers are active for the account. If no fee waivers are active for the account, process 200 may continue at step 224. At step 224, the system may assess fees for the account. In some embodiments, at step 224, the system may select a message with which to communicate to the customer about the fees. The message may be communicated in a letter, on an account statement, in an electronic mail message, on a web site, by telephone or by any other suitable communication.

Process 200 may continue during a third monthly billing cycle (“Billing Cycle: Month 3”) of the account. The first step of the third billing cycle may be step 226. At step 226, a Month 2 Billing Cycle Statement may be issued. At step 228, process 200 may be repeated.

If at step 222 (in Billing Cycle: Month 2) the system determines that one or more fee waivers are active for the account, process 200 may proceed from step 222 to step 230. At step 230, one or more of the active fee waivers may be waived. One or more messages like those described in connection with step 224 may be communicated to the customer in connection with any waivers at step 230. Process 200 may then continue during Billing Cycle: Month 3 at step 226, which is described above.

If at step 220 (in Billing Cycle: Month 2) the system determines that a threshold, such as “10× Achieved,” has been met, process 200 may continue at step 232. At step 232, the system may determine whether existing fee waivers are in place. If at step 232 the system determines that existing fee waivers are in place, process 200 may proceed from step 232 to step 234. At step 234, the system may communicate to the customer a message such as “By using your check card, the bank provides you another way to reduce or avoid your fee.” The fee may be a minimum monthly fee (“MMF”), a flat monthly fee, a per-transaction fee or any other suitable type of fee. At step 236, the Month 2 billing cycle may end. Process 200 may continue during Billing Cycle: Month 3 at step 226, which is described above.

If at step 232 the system determines that existing fee waivers are not in place, process 200 may proceed from step 232 to step 238. At step 238, the system may communicate to the customer a message such as “Because you have used your check card 10× or more, your fee has been waived.” The fee may be any type of fee, including, for example, the fee described in connection with step 234. Process 200 may continue at step 236, which is described above.

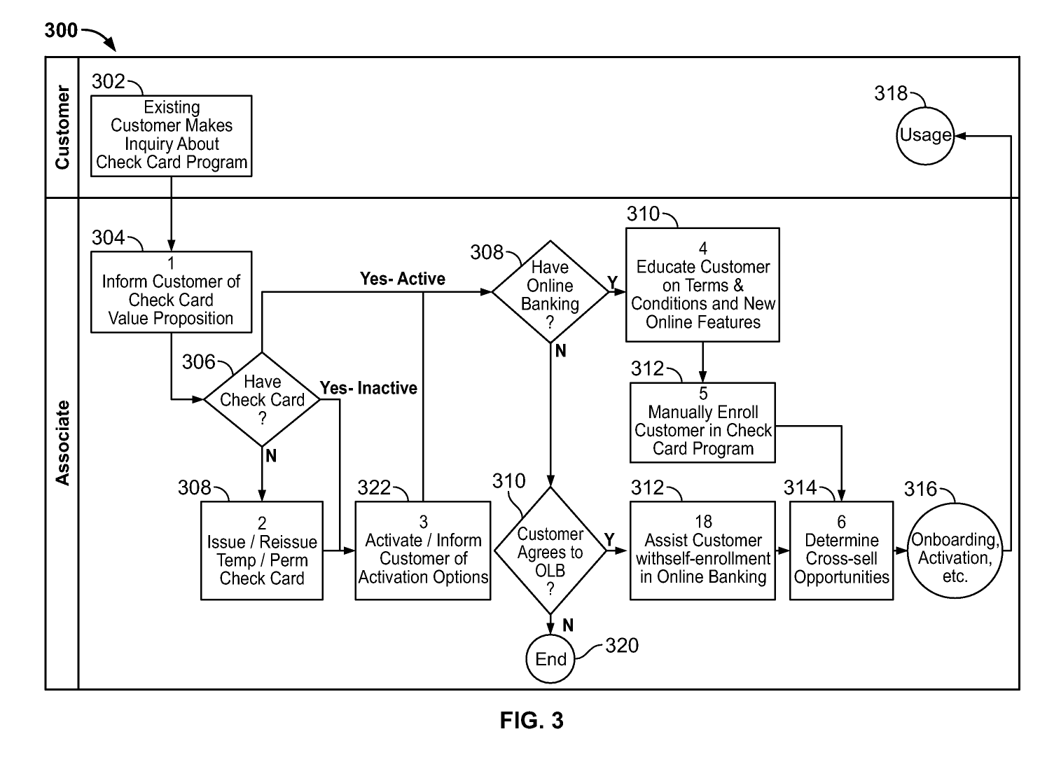

FIG. 3 shows illustrative process 300 for enrollment in a check card program. Process 300 may be used when an existing bank customer desires to enroll in a check card program. Process 300 may begin at step 302. Step 302 may be initiated or controlled by the customer. At step 302, the customer may make an inquiry about a check card program. The check card program may be a small business check card program. The customer may be a small business (or a representative thereof). The business may already be a customer of a bank or the entity that performs process 300.

Process 300 may continue at step 304. Step 304 is one step of several that may be initiated or controlled by a bank associate or another entity on behalf of the system. At step 304, the associate may inform the customer about a check card value proposition. Check card value propositions may include, for example, waiver of a fee, online account management features and any other suitable value proposition.

At step 306, the associate may determine whether the customer has a check card. If the customer has a check card, and the check card is active, process 300 may continue at step 308. At step 308, the associate may determine whether the customer has an online banking service. If the customer does have online banking service, process 300 may continue at step 310. At step 310, the associate may educate the customer regarding terms and conditions related to the check card, online banking features, online check card features and any other suitable features.

At step 312, the associate may enroll the customer in the check card program. At step 314, the associate may determine cross-sell opportunities. At step 316 the associate may initiate onboarding activities, check card activation or any other suitable processes. Process 300 may continue under the control of the customer at step 318. At step 318, the customer may use the check card for a transaction.

If at step 308 the associate determines that the customer does not have online banking service, process 300 may proceed from step 308 to step 310. At step 310 the customer may decide whether to enroll in online banking (“OLB”). If at step 310 the customer decides to enroll in OLB, process 300 may continue at step 312. At step 312, the associate may assist the customer with self-enrollment (or any other type of enrollment) in OLB. Process 300 may continue at step 314, which is described above.

If at step 310 the customer decides not to enroll in OLB, process 300 may proceed from step 310 to step 320. Process 300 may end at step 320. In some embodiments, the customer may be informed that at the customer's convenience, the customer may enroll in online banking in the future.

If at step 306 the associate determines that the customer has a check card that is inactive, process 300 may proceed from step 306 to step 322. At step 322, the associate may activate the check card. The associate may inform the customer about options regarding the activation of the check card. The options may include activating the check card at an ATM, via telephone or by any other suitable action.

If at step 306 the associate determines that the customer does not have a check card, process 300 may proceed from step 306 to 308. At step 308, the associate may issue a check card to the customer. The associate may reissue a check card to the customer. The check card may be a permanent check card or a temporary check card.

The temporary check card may be a card that is embossed with a non-personalized identification, such as “VIP Customer.” The temporary check card may be activated immediately upon opening a check card account. The activation may be performed at a bank branch office (viz., a “banking center”) or other convenient location. The temporary check card may provide the customer with immediate access to the customer's funds. Permanent check cards may be embossed with the customer's name. Permanent check cards may be delivered to customers by postal mail. Postal mail may require seven to ten days for delivery. Temporary check cards may thus provide the customer with check card service between the time an account is opened and the time a permanent check card arrives in the mail.

Process 300 may continue at step 322, which is described above.

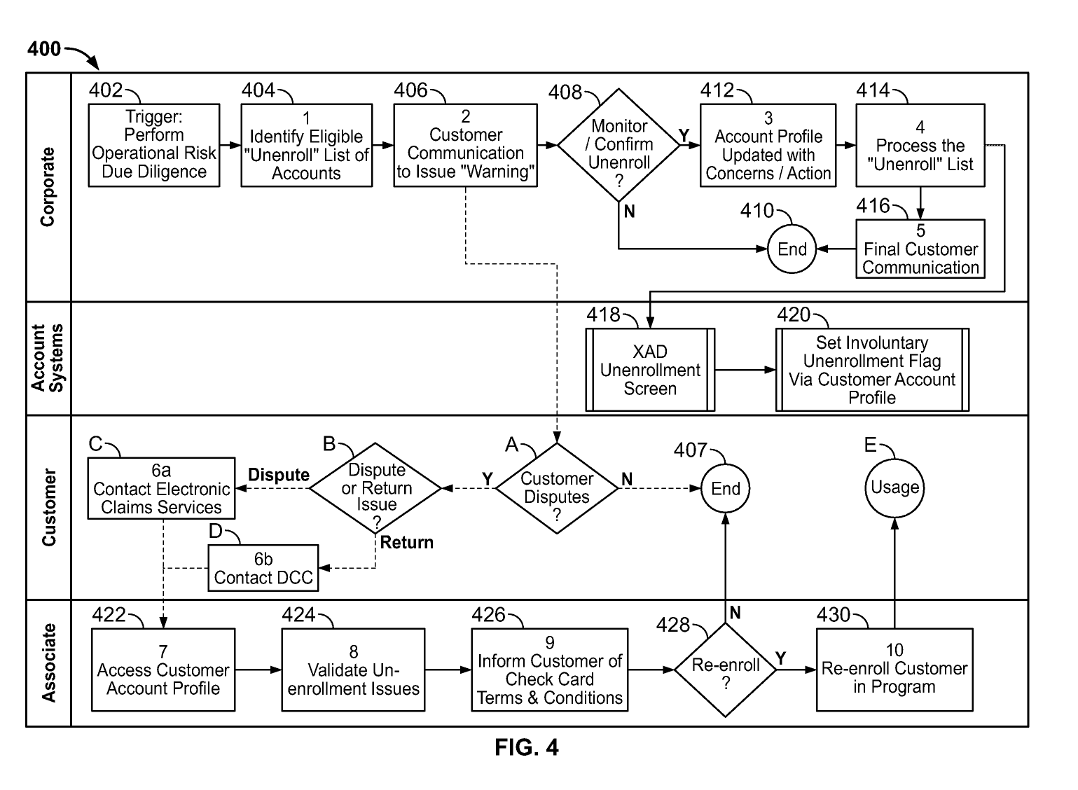

FIG. 4 shows illustrative process 400 for mitigating against risks from gaming customers. Process 400 may begin at step 402. Step 402 and some subsequent steps may be performed under the control of a corporate arm of the entity that performs process 400.

At step 402, the corporate arm may perform an operational risk due diligence. At step 404, the corporate arm may identify eligible “unenroll” accounts. The accounts may be identified in a list. At step 406, the corporate arm may issue a customer communication to warn customers regarding prohibited activity. Process 400 may then bifurcate into a first fork and a second fork.

The first fork of process 400 may begin at step 408. At step 408, the corporate arm may confirm that the customer is to be unenrolled. If at step 408 the corporate arm determines that the customer is not to be unenrolled, process 400 may end at step 410.

If at step 408 the corporate arm determines that the customer is to be unenrolled, process 400 may continue proceed from step 408 to step 412. At step 412, the customer's account profile may be updated with information about the corporate arm's concerns and/or action that has been taken in connection with the concerns and/or action. At step 414, the corporate arm may process the unenroll list. Processing the unenroll list may involve removing listed customers from the check card fee waiver program.

After step 414, the corporate arm may perform step 416. At step 416, a final customer communication may be issued. The final customer communication may inform the customer that the customer's check card program privileges have been suspended, terminated, revoked or otherwise interrupted. The final communication may inform the customer that the entity has interrupted one or more other services or privileges associated with the check card program, the check card account or other accounts that are used by the customer.

After step 414, the corporate arm may trigger action on the part of an account systems arm of the entity. Steps 418 and 420 may be performed under the control of the account systems arm. In some embodiments, the steps of the account systems arm may be performed in parallel with steps 412, 414, 416 and 410. Process 400 may proceed from step 414 to step 418. At step 418, an account systems arm representative may view an unenrollment screen. The unenrollment screen may be an extend account database “XAD” unenrollment screen. At step 420, the account systems arm representative may use a customer account profile to set an involuntary unenrollment flag. The customer account profile may be accessed via a front end system that is available to account management and customer service representatives of the entity. The flag may interrupt check card service as described above in connection with step 416.

The second fork of process 400 may begin at step 422. Step 422 and some subsequent steps may be performed by by an associate representing the entity. The performance of step 422 may be contingent upon actions that may be taken by the customer, are not under the control of the entity, and are not performed by the system. Actions A, B, C, D and E, and other possible actions, may be undertaken by the customer.

Action A may be undertaken in response to a corporate arm warning communication at step 406. In action A, the customer may decide whether to dispute some or all of the communication of step 406. If the customer decides not to dispute any of the communication, process 400 may end at step 407. If in action A the customer decides to dispute some or all of the communication, the customer may undertake action B. In action B, the customer may determine whether to dispute the communication or the returned item or items. If in action B the customer decides to dispute the communication, the customer may undertake action C. At action C, the customer may contact electronic claims services representatives of the entity. If in action B the customer decides to return the check card item, the customer may undertake action D. In action D, the customer may contact a customer service call center, such as a Deposit Contact Center (“DCC”).

Whether the customer undertakes action C or D, process 400 may be resumed at step 422 under the control of the associate representing the entity. At step 422, the associate may access a customer account profile corresponding to the customer. The associate may access the customer account profile via a front end system that is similar or identical to that used in step 420.

At step 424, the associate may validate unenrollment issues. Validation of unenrollment issues may involve comparing customer account information to the communication sent at step 406. At step 426, the associate may inform the customer about check card terms and conditions. At step 428, the customer may choose to re-enroll in the check card program. If at step 428 the customer chooses not to re-enroll in the check card program, process 400 may end at step 407. If at step 428 the customer chooses to re-enroll in the check card program, process 400 may proceed from step 428 to step 430. At step 430, the associate may re-enroll the customer in the program. The customer may then undertake action E. In action E, the customer may use the check card for transactions.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for waiving a fee for a banking service have been provided. Persons skilled in the art will appreciate that the present invention can be practiced by other than the described embodiments, which are presented for purposes of illustration rather than of limitation. The present invention is limited only by the claims that follow.

What is claimed is:

1. A method for waiving at least a portion of a fee for a banking service, the method comprising:
providing a check card to a customer;
tallying a usage metric related to transactions executed using the check card;
comparing the usage metric to a preselected requirement; and
if the usage metric is not less than the requirement, waiving at least the portion of the fee.

2. The method of claim 1 further comprises receiving from the customer a selection of an alert instruction that defines a condition under which the customer will receive a check card alert.

3. The method of claim 2 further comprising communicating the check card alert to the customer at a point of sale.

4. The method of claim 3 wherein the communicating comprises transmitting a signal that causes the check card alert to be displayed to the customer on an electronic display.

5. The method of claim 3 wherein the communicating comprises transmitting a signal that causes the check card alert to be printed on a transaction receipt.

6. The method of claim 1 wherein the tallying a usage metric comprises tallying a number of transactions in which the check card was used.

7. The method of claim 1 wherein the tallying a usage metric comprises tallying a monetary value of transactions in which the card was used.

8. The method of claim 1 further comprising including in a billing cycle statement information based on the usage metric.

9. The method of claim 1 further comprising identifying the customer as a candidate for involuntary unenrollment.

10. The method of claim 9 further comprising withdrawing a check card privilege from the customer.

11. One or more computer-readable media storing computer-executable instructions which, when executed by a processor on a computer system, performs a method for waiving at least a portion of a fee for a banking service, the amount corresponding to currency having a uniform denomination that is one of several denominations, the method comprising:
providing a check card to a customer;
tallying a usage metric related to transactions executed using the check card;
comparing the usage metric to a preselected requirement; and
if the usage metric is not less than the requirement, waiving at least the portion of the fee.

12. The media of claim 11 wherein, in the method, further comprises receiving from the customer a selection of an alert instruction that defines a condition under which the customer will receive check card alert.

13. The media of claim 12 wherein the method further comprises communicating the check card alert to the customer at a point of sale.

14. The media of claim 13 wherein, in the method, the communicating comprises transmitting a signal that causes the check card alert to be displayed to the customer on an electronic display.

15. The media of claim 13 wherein, in the method, the communicating comprises transmitting a signal that causes the check card alert to be printed on a transaction receipt.

16. The media of claim 11 wherein, in the method, the tallying a usage metric comprises tallying a number of transactions in which the check card was used.

17. The media of claim 11 wherein, in the method, the tallying a usage metric comprises tallying a monetary value of transactions in which the card was used.

18. The media of claim 11 wherein the method further comprises including in a billing cycle statement information based on the usage metric.

19. The media of claim 11 wherein the method further comprises identifying the customer as a candidate for involuntary unenrollment.

20. The media of claim 19 wherein the method further comprises withdrawing a check card privilege from the customer.
